(19) United States
(12) Patent Application Publication
(10) Pub. No.: US 2026/0212049 A1
(43) Pub. Date: Jul. 23, 2026

(54) STORAGE AND CHECK SYSTEM, AND SERVER

(71) Applicant: SUZHOU METABRAIN INTELLIGENT TECHNOLOGY CO., LTD., Suzhou, Jiangsu (CN)

(72) Inventors: Zeyi LIANG, Suzhou, Jiangsu (CN); Jianlong SU, Suzhou, Jiangsu (CN); Mingming WANG, Suzhou, Jiangsu (CN)

(21) Appl. No.: 19/141,675

(22) PCT Filed: Nov. 13, 2023
(86) PCT No.: PCT/CN2023/131334

§ 371 Date: Jun. 20, 2025

(30) Foreign Application Priority Data
Dec. 20, 2022 (CN) 202211636479.9

(51) Int. Cl. G06F 21/78; G06F 13/16

(52) U.S. Cl. CPC G06F 21/78; G06F 13/1621; G06F 13/1689

(57) ABSTRACT

Provided in the present application are a storage and check system, and a server. The system comprises: a gating and arbitration module, which is connected to each host interface; a storage controller module, which is configured to receive a host interface command and data which are sent by the gating and arbitration module, parse the received host interface command, and send decoded data to each host interface; and an ECC codec module, which sends an interface selection indication signal to the gating and arbitration module, such that the gating and arbitration module selects a corresponding host interface, wherein the ECC codec module receives the host interface command and the data which are sent by the storage controller module, encodes or decodes the data on the basis of the host interface command, and sends the encoded or decoded data to the storage controller module. By using the solution of the present application, the data error correction capability can be improved, a storage space can be saved on, and the resource consumption can be significantly reduced. The present application relates to the field of computers.

### CROSS-REFERENCE TO RELATED APPLICATION

The present application claims priority to Chinese patent application No. 202211636479.9, entitled “SYSTEM AND SERVER FOR STORAGE VERIFICATION”, filed on Dec. 20, 2022 before the China National Intellectual Property Administration, which is incorporated herein in its entirety by reference.

### TECHNICAL FIELD

This application relates to the field of computers, in particular to a system and a server for storage verification.

### BACKGROUND

Since no storage can guarantee reliable performance throughout its entire life cycle, it is necessary to set check codes for correcting data errors or detecting and reporting errors. The ECC (Error-Correcting Code) algorithm is widely used in storage verification due to its simple hardware implementation, low consumption of logic resources, low decoding delay, and the characteristic of Single Error Correction-Double Error Detection (SEC-DED). The ECC code (SEC-DED code) is a type of linear block code that can correct 1-bit errors and detect 2-bit errors, but it cannot guarantee the detection of errors exceeding 2 bits.

### SUMMARY

In view of the above, an objective of embodiments of this application is to provide a system and server for storage verification.

Based on the above objective, one aspect of the embodiments of this application provides a storage verification system, including:
a gating and arbitration module, connected to all host interfaces and configured to receive data sent from the host interfaces and send data to the host interfaces;
a storage controller module, connected to the gating and arbitration module and configured to receive a host interface command and data sent from the gating and arbitration module, parse the host interface command received, and send decoded data to each host interface;
an ECC codec module connected to the gating and arbitration module and the storage controller module, wherein the ECC codec module is configured to: send an interface selection indication signal to the gating and arbitration module to enable the gating and arbitration module to select a corresponding host interface; receive the host interface command and data sent from the storage controller module, encode or decode the data based on the host interface command, and send encoded or decoded data to the storage controller module; and
a storage module connected to the storage controller module, wherein the storage module is configured to store the encoded data and ECC parity data sent from the storage controller module, and send the encoded data and ECC parity data to the ECC codec module.

In an embodiment of the present application, the storage module includes several partitions with a different security levels, a storage space for the ECC parity data in a partition with a high security level is larger than a storage space for the ECC parity data in a partition with a low security level; the storage module is configured to store the encoded data and the ECC parity data into corresponding partitions based on the security levels of the data sent from different host interfaces.

In an embodiment of the present application, the gating and arbitration module includes a host interface gating unit connected to all host interfaces, and the host interface gating unit is configured to receive the interface selection indication signal sent from the ECC codec module, and receive the host interface command and data sent from the host interface based on the received interface selection indication signal.

In an embodiment of the present application, the gating and arbitration module further includes an arbiter connected to the host interface gating unit and the storage controller module; the arbiter is configured to: arbitrate, among a plurality of host interface commands and data received by the host interface gating unit, using a round-robin scheduling algorithm; select a group of host interface command and data among the plurality of host interface commands and data; and send the group of host interface command and data to the storage controller module.

In an embodiment of the present application, the gating and arbitration module further includes a monitor connected to the host interface gating unit and the ECC codec module, wherein the monitor is configured to, in response to determining that no request signal exists at the arbiter and request signals exist at the host interface gating unit, send an H matrix switching signal to the ECC codec module; in response to receiving the H matrix switching signal, the ECC codec module sends new interface selection indication signal to the host interface gating unit, allowing new host interface command and data to enter the arbiter.

In an embodiment of the present application, the monitor is connected to the arbiter, and is further configured to, in response to determining that a threshold number of commands and data of the current host interface are continuously processed and requests from other host interfaces exist in the arbiter, send a timeout signal to the ECC codec module, allowing commands and data of other host interfaces in the arbiter to be sent to the storage controller module.

In an embodiment of the present application, the storage controller module includes a command parsing unit connected to the gating and arbitration module, the command parsing unit is configured to receive the host interface command and data sent from the gating and arbitration module, and parse the host interface command into a read command, a write command, an encoding/decoding mode, a host interface type, and a target address.

In an embodiment of the present application, the storage controller module further includes a storage read sequence generation unit and an ECC control module; the storage read sequence generation unit is configured to receive information about the read command and target address parsed by the command parsing unit, generate a storage read control instruction based on the information, and send the storage read control instruction to the storage module to read corresponding data to be encoded/decoded in the storage module into the ECC control module; the ECC control module is configured to receive information about the encoding/decoding mode and the host interface type parsed by the command parsing unit, send the encoding/decoding mode, the host interface type, and the data to be encoded/decoded to the ECC codec module for processing; the ECC control module is further configured to receive the encoded/decoded data sent from the ECC codec module, perform ECC verification on the encoded/decoded data, and send the verified data to the gating and arbitration module.

In an embodiment of the present application, the storage controller module further includes a storage write sequence generation unit; the storage write sequence generation unit is configured to receive information about the write command and target address parsed by the command parsing unit, generate a storage write control instruction based on the information, and send the storage write control instruction to the storage module; the ECC control module is configured to receive information about the encoding/decoding mode, the host interface type, and write data source parsed by the command parsing unit, send the encoding/decoding mode, the host interface type, and the write data source to the ECC codec module for processing; the ECC control module is further configured to receive the encoded/decoded data sent from the ECC codec module and send the encoded/decoded data to the storage write sequence generation unit; the storage write sequence generation unit writes the encoded/decoded data into the storage module.

In an embodiment of the present application, the ECC codec module includes an H matrix storage module configured to store two sets of H matrices, and the H matrix storage module includes a register group, and each register in the register group is used for storing one row of data in the H matrix.

In an embodiment of the present application, a number of registers in the register group is twice a number of rows in the H matrix with the largest number of rows among all H matrices.

In an embodiment of the present application, the H matrix storage module is connected to an external matrix configuration module; the H matrix storage module is configured to receive configuration information sent from the external matrix configuration module, and update the H matrices stored in the H matrix storage module based on the configuration information.

In an embodiment of the present application, the H matrix storage module is configured to fill redundant bits in the data stored in each register with zeros.

In an embodiment of the present application, the ECC codec module further includes an organization module that is connected to the H matrix storage module and configured to receive each row of data in the H matrix sent from the H matrix storage module and organize the received rows of data into the H matrix.

In an embodiment of the present application, the organization module is further configured to, in response to the ECC codec module being in the encoding mode, select a set number of high-order bits from each row of data to form the H matrix and fill zeros in high-order bits of the formed H matrix.

In an embodiment of the present application, the set number is a value obtained by subtracting the number of parity bits from the number of columns of the H matrix.

In an embodiment of the present application, the organization module is further configured to, in response to the ECC codec module being in the decoding mode, select a preset number of low-order bits from each row of data to form the H matrix.

In an embodiment of the present application, the preset number is the number of columns of the H matrix.

In an embodiment of the present application, the ECC codec module further includes a calculation module connected to the organization module and the storage controller module; the calculation module is configured to receive the data to be encoded/decoded sent from the storage control module and the H matrix sent from the organization module, encode/decode the data to be encoded/decoded according to the H matrix, and send the encoded/decoded data to the storage controller module.

Another aspect of the embodiments of the present application also provides a server including a storage verification system, wherein the storage verification system includes:
a gating and arbitration module, connected to all host interfaces and configured to receive data sent from the host interfaces and send data to the host interfaces;
a storage controller module, connected to the gating and arbitration module and configured to receive a host interface command and data sent from the gating and arbitration module, parse the host interface command received, and send decoded data to the host interfaces;
an ECC codec module connected to the gating and arbitration module and the storage controller module, wherein the ECC codec module is configured to: send an interface selection indication signal to the gating and arbitration module to enable the gating and arbitration module to select a corresponding host interface; receive the host interface command and data sent from the storage controller module, encode or decode the data based on the host interface command, and send encoded or decoded data to the storage controller module; and
a storage module connected to the storage controller module, wherein the storage module is configured to store the encoded data and ECC parity data sent from the storage controller module, and send the encoded data and the ECC parity data to the ECC codec module.

### BRIEF DESCRIPTION OF THE DRAWINGS

In order to describe technical solutions of the embodiments of the present disclosure or the related art more clearly, the accompanying drawings used in the illustration of the embodiments or the related art will be briefly introduced. Apparently, the accompanying drawings in the following explanation illustrate merely some embodiments of the present disclosure, and those skilled in the art may obtain other embodiments based on these accompanying drawings without paying any creative effort.

FIG. 1 is a schematic diagram of a storage verification system according to an embodiment of this application;

FIG. 2 is a schematic diagram of a gating and arbitration module according to an embodiment of this application;

FIG. 3 is a schematic diagram of a storage controller module according to an embodiment of this application;

FIG. 4 is a schematic diagram of an ECC codec module according to an embodiment of this application;

FIG. 5 is a schematic diagram illustrating selecting a parity-check matrix by an organization module according to an embodiment of this application; and

FIG. 6 is a schematic diagram of a tree-based computation process of a calculation module according to an embodiment of this application.

### DETAILED DESCRIPTION OF THE EMBODIMENTS

The embodiments of the present disclosure will be described hereinafter. However, it should be understood that the disclosed embodiments are merely examples, and other embodiments may take various alternative forms. The drawings are not necessarily to scale; some features may be exaggerated or minimized to show details of particular components. Therefore, specific structural and functional details disclosed herein are not to be interpreted as limiting, but merely as a representative basis for teaching those skilled in the art to variously use the present application. As will be understood by those skilled in the art, various features shown and described with reference to any one drawing may be combined with features shown in one or more other drawings to produce embodiments that are not explicitly shown or described. Combinations of the shown features provide representative embodiments for typical applications. However, various combinations and modifications of features consistent with the teachings of this disclosure may be desirable for certain specific applications or implementations.

The generator matrix for ECC is as follows:

$$G = [ {I}_{k} \cdot P ] [ \begin{matrix}1 & 0 & 0 & … & 0 & {p}_{1 , 1} & {p}_{1 , 2} & … & {p}_{1 , n - k} \\ 0 & 1 & 0 & & 0 & {p}_{2 , 1} & {p}_{2 , 2} & … & {p}_{2 , n - k} \\ 0 & 0 & 1 & & 0 & {p}_{3 , 1} & {p}_{3 , 2} & … & {p}_{3 , n - k} \\ … & … & … & & … & … & … & … & … \\ 0 & 0 & 0 & … & 1 & {p}_{k , 1} & {p}_{1 , k 2} & … & {p}_{k , n - k}\end{matrix} ]$$

where the generator matrix G is of k*n dimensions. In the formula, Iₖ is a k*k identity matrix, and the elements in P are integers of 0 or 1. As can be seen from the generator matrix, the ECC code is a systematic code among linear block codes. The data information to be encoded is: u=(u₁, u₂, u₃, . . . , uₖ). The codeword obtained through encoding with the G matrix is: v=(u₁, u₂, . . . , uₖ). G=(v₁, v₂, . . . , vₙ). The first k components in the obtained codeword v are the original data information, the last n-k components in the obtained codeword v are parity bits, and n is the code length.

The parity-check matrix for ECC is as follows:

$$H = [ {P}^{T} \cdot {I}_{n - k} ] [ \begin{matrix}{p}_{1 , 1} & {p}_{2 , 1} & … & {p}_{k , 1} & 1 & 0 & … & 0 \\ {p}_{1 , 2} & {p}_{2 , 2} & … & {p}_{k , 2} & 0 & 1 & … & 0 \\ {p}_{1 , 3} & {p}_{2 , 3} & … & {p}_{k , 3} & 0 & 0 & … & 0 \\ … & … & & … & … & … & … & … \\ {p}_{1 , n - k} & {p}_{2 , n - k} & … & {p}_{k , n - k} & 0 & 0 & … & 1\end{matrix} ]$$

According to the definitions of the generator matrix G and the parity-check matrix H, there exists a simple transformation relationship between G and H, and v·H^{T}=0. Given that the codeword received by the decoder is r=(r₁, r₂, . . . , rₙ), the original codeword y might have experienced errors in certain bits during storage. Accordingly, r is not necessarily identical to v, but rather a sequence including the error pattern e, i.e., r=v+e. The syndrome s is calculated as s=r·H^{T}=(v+e). H^{T}. When the error pattern e is 0, s=v·H^{T}=0; when error pattern e is not 0, s=r·H^{T}=(v+e). H^{T}=e·H^{T}.

As can be seen from the above, the error pattern e can be derived by solving s=e·H^{T}. It should be noted that since addition is used in place of subtraction in modulo-2 arithmetic, the correct codeword can be obtained by v=r+e.

The decoding method for ECC codes is simple, which leverages the differences among syndromes s. A lookup table is used to determine the error patterns e corresponding to different syndromes s. Since the ECC code can be used to correct single-bit errors and detect random double-bit errors simultaneously, their parity-check matrix H must satisfy the following rules: (1) All column vectors are distinct from one another. (2) The Hamming weight of each column vector is an odd number.

When a single-bit error occurs in the codeword (i.e., the error pattern vector e contains only one ‘1’), according to s=e·H^{T}, the syndrome s will be equal to a specific column of the matrix H, and there is a one-to-one correspondence between s and e. Therefore, Rule (1) ensures that the syndromes for all single-bit errors are distinct. This allows to use a lookup table to find the error pattern e corresponding to the current syndrome s, and then correct the error through v=r+e.

When a double-bit error occurs in the codeword (i.e., the error pattern vector e contains two ‘l’s), according to s=e·H^{T}, the syndrome s will be equal to the XOR result of two specific columns of the matrix H. To detect random double-bit errors, the syndrome of the double-bit error can not be equal to the syndrome of any single-bit error. Therefore, the XOR result of any two column vectors in the matrix H is not equal to any column vector in H. Rule (2) is established to meet this requirement. When the Hamming weight of all column vectors in the matrix His odd, the Hamming weight of the XOR result of any two column vectors must be even. Therefore, Rule (2) enables the ECC code to determine whether a random double-bit error has occurred in the codeword simply by checking the parity of the non-zero syndrome.

When the data bit width is merely 8 bits, 5 bits are required for ECC verification. As the data bit width doubles, only one additional bit is needed for ECC. That is, if the data bit width is 16 bits, then 6 bits are required for ECC verification; if the data bit width is 32 bits, then 7 bits are required for ECC verification; and if the data bit width is 64 bits, then 8 bits are required for ECC verification. Based on the mathematical properties of ECC verification codes, it can be determined that for the original data of the same length, the longer the ECC verification code, the stronger the error-correcting ability, that is, the greater the tolerance for errors in the original data.

Most ECC encoders and decoders implemented in hardware on the market only support either encoding or decoding functions. The bit width of the data to be encoded is fixed and cannot be adjusted according to the varying security requirements of the data to be stored. Moreover, the parity-check matrix is fixed and cannot be reconfigured during use. This results in using ECC codes with the same code rate to verify data of different security levels, so that the error correction capability is insufficient for data with a high security level, while excessive storage space is wasted for data with a low security level.

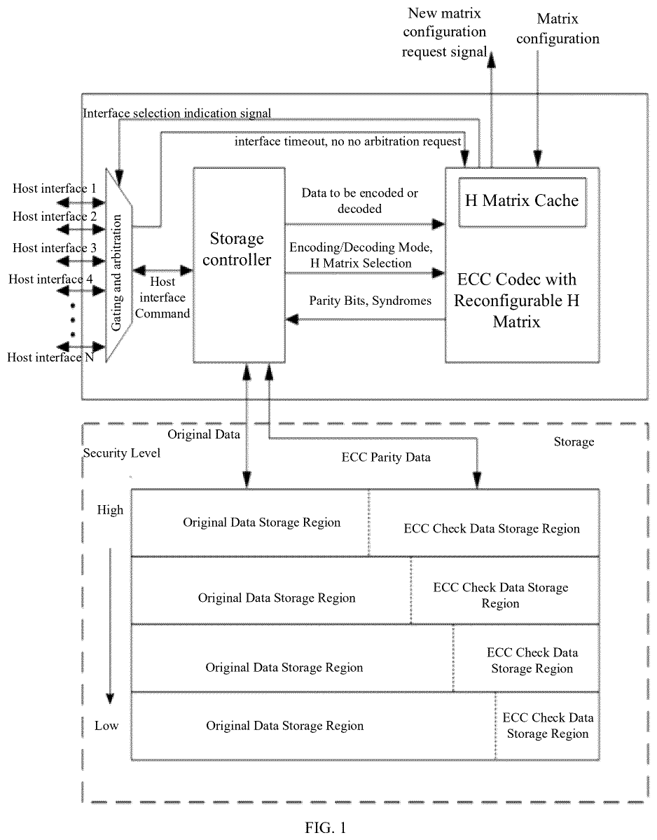

In view of the above objectives, a first aspect of the embodiments of the present application provides an embodiment of a storage verification system. FIG. 1 is a schematic diagram of the storage verification system.

As shown in FIG. 1, the storage verification system may include a gating and arbitration module that is connected to various host interfaces and configured to receive data sent from the host interfaces and send data to the host interfaces.

The storage verification system may also include a storage controller module. The storage controller module is connected to the gating and arbitration module, and configured to receive host interface commands and data sent from the gating and arbitration module, parse the host interface commands received, and send decoded data to various host interfaces. When a host interface command is received, the storage controller module determines whether it is an encoding or a decoding mode and configures the mode of the ECC codec module first, and then sends the data to be encoded/decoded into the ECC codec module. The ECC codec module supports two modes, that is, the encoding mode and the decoding mode. In the encoding mode, the storage controller module sends the data to be encoded to the ECC codec module for encoding; the ECC codec module returns parity bits obtained through encoding to the storage controller module; the storage controller module determines which security-level area in the storage corresponds to the host interface that is processed currently, and then sends both the original data and the parity data to the corresponding area for storage. In the decoding mode, the storage controller module determines the host interface to be processed, reads the encoded data and ECC parity data from the corresponding security-level area of the storage module for splicing, sends the spliced data together to the ECC codec module; the ECC codec module decodes the spliced data and returns the syndrome; the storage controller module completes the ECC single-error correction and double-error detection verification, and finally sends the verified data to the corresponding host interface.

The storage verification system also includes an ECC codec module connected to the gating and arbitration module and the storage controller module. The ECC codec module is configured to send an interface selection indication signal to the gating and arbitration module to enable the gating and arbitration module to select a corresponding host interface. The ECC codec module is further configured to receive the host interface commands and data sent from the storage controller module, encode or decode the data based on the host interface commands, and send the encoded or decoded data to the storage controller module. The ECC codec module may cache a preset number of H matrices, preferably only two H matrices. These two H matrices should correspond to at least two host interfaces. The ECC codec module sends an interface selection signal to the gating and arbitration module to select the host interfaces for which the corresponding H matrices are already cached. The commands and data of these interfaces are sequentially sent to the storage controller module for processing. If the selected host interfaces no longer send a request signal and there are request signals on other host interfaces, an arbiter sends an H matrix switching signal to the ECC codec module. Then, the ECC codec module sends a request to an external matrix configuration module. After receiving the request, the external matrix configuration module provides two new H matrices into the ECC codec module. After the configuration is completed, the interface selection signal is changed to process commands of a new host interface. Moreover, a timeout mechanism is introduced. When the number of commands continuously processed from the currently selected host interface exceeds a certain amount and there are requests from other host interfaces, the gating and arbitration module sends an interface timeout signal to the ECC codec module, forcing the ECC codec module to send the H matrix switching request externally and change and select new interfaces.

The storage verification system also includes a storage module connected to the storage controller module. The storage module is configured to store the encoded data and ECC parity data sent from the storage controller module, and send the encoded data and ECC parity data to the ECC codec module. The storage space of the storage module can be partitioned, with different security levels set for different regions. Different access regions are distinguished according to the currently processed different host interfaces. A region with a high security-level is allocated more storage space for parity bits than a region with a low security-level.

Through the technical solution of the present application, data error correction capability can be increased, storage space can be saved, and resource consumption can be significantly reduced.

In a preferred embodiment of the present application, the storage module includes several partitions, each with a different security level. The ECC parity data in a partition with the high security-level has a larger storage space than the ECC parity data in a partition with the lower security-level. The storage module is configured to store the encoded data and ECC parity data into the corresponding partitions based on the security levels of the data sent from different host interfaces. When dividing the storage module into multiple partitions and setting different security levels for each partition, it is necessary to ensure that the partitions with the high security-level have a larger storage space for the ECC parity data than the partitions with the low security-level. That is to say, according to the different data security levels of users, ECC codes with different code rates are used for verification, which can increase the error correction capability of data with a high security-level.

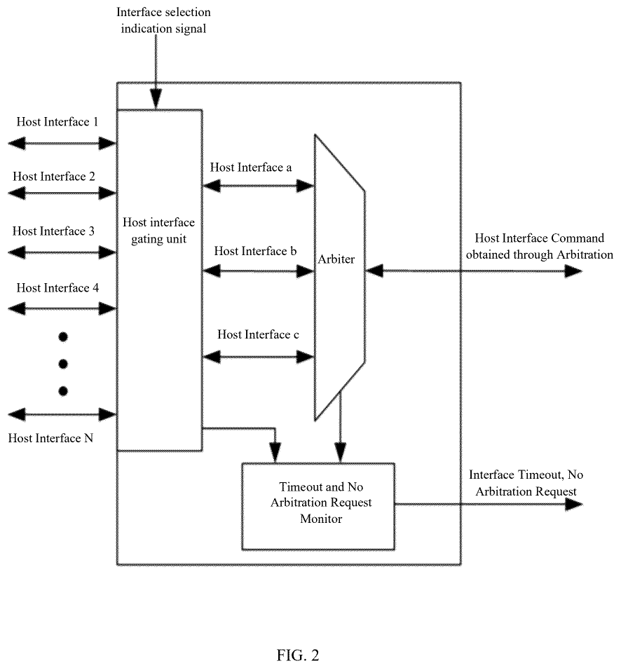

In a preferred embodiment of the present application, as shown in FIG. 2, the gating and arbitration module includes a host interface gating unit connected to various host interfaces. The host interface gating unit is configured to receive the interface selection indication signal sent from the ECC codec module, and receive the host interface commands and data sent from the host interface based on the received interface selection indication signal. The host interface gating unit connects to a corresponding host according to the received interface selection indication signal, and receives commands and data from interfaces of the host. For example, if the received selection indication signal instructs to select interface a, interface b, and interface c, the interface gating unit connects these three host interfaces and receives the commands and data from these three host interfaces.

In a preferred embodiment of the present application, as shown in FIG. 2, the gating and arbitration module further includes an arbiter connected to the host interface gating unit and the storage controller module. The arbiter uses a round-robin scheduling algorithm for arbitration. The arbiter is configured to arbitrate among multiple host interface commands and data received from the host interface gating unit to select a group of the host interface command and data among multiple host interface commands and data, and send them to the storage controller module. Since the ECC codec module can only use one H matrix for encoding/decoding operations at a time, the arbiter is needed to arbitrate the commands and data from the three selected host interfaces as described above. That is, one of the three host interfaces is selected, and the host interface commands and data of this interface are sent downward, while keeping the other two host interfaces in awaiting state.

In a preferred embodiment of the present application, as shown in FIG. 2, the gating and arbitration module further includes a monitor connected to the host interface gating unit and the ECC codec module. The monitor is configured to send an H matrix switching signal to the ECC codec module when there is no request signal from the arbiter but there is a request signal from the host interface gating unit. After receiving the H matrix switching signal, the ECC codec module resends an interface selection indication signal to the host interface gating unit, allowing new host interface commands and data to enter the arbiter. When the monitor detects that there is no request signal from the arbiter (that is, the commands and data of the host interfaces in the arbiter have been processed, in other words, all the data that can be processed by the H matrix cached in the ECC codec module has been processed and other data cannot be processed by using the currently cached H matrix), if there are still requests from external host interfaces at this time, the H matrix cached in the ECC codec module needs to be replaced. After the H matrix is replaced, a new interface selection indication signal is sent according to the H matrix, so as to select, via the host interface gating unit, the host interfaces that can be processed by the current H matrix.

In a preferred embodiment of the present application, the monitor is connected to the arbiter, and is further configured to send a timeout signal to the ECC codec module when the number of commands and data continuously processed of the current host interface exceeds a threshold and there are requests from other host interfaces in the arbiter. This enables the commands and data of other host interfaces in the arbiter to be sent to the storage controller module. In order to prevent the ECC codec module from continuously processing data from the same host interface while other host interfaces remain in awaiting state, the monitor also tracks the number of host interface commands processed for the same host interface. If the monitor detects that the threshold number of host interface commands from the same host interface are continuously processed and there are still commands from other host interfaces in the arbiter, after the current host interface command is processed, the arbiter will send the commands and data of other host interfaces downward for processing, ensuring the fairness of arbitration.

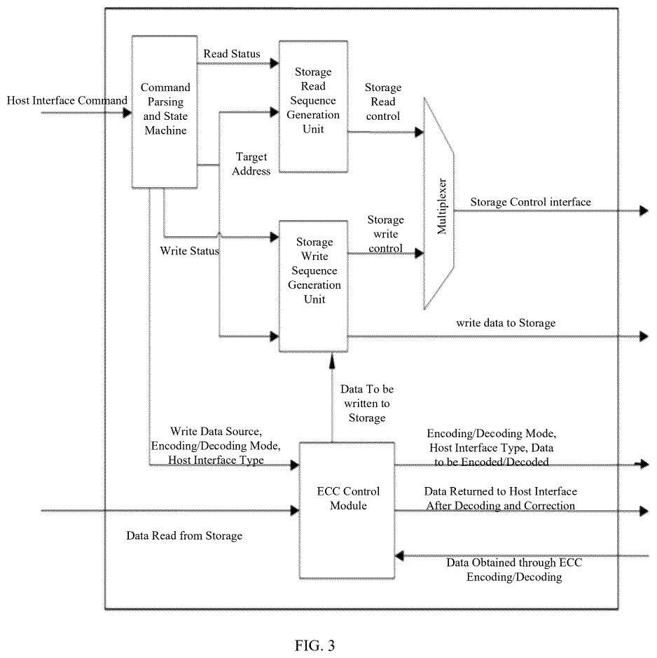

In a preferred embodiment of the present application, as shown in FIG. 3, the storage controller module includes a command parsing unit connected to the gating and arbitration module and configured to receive the host interface commands and data sent from the gating and arbitration module. The command parsing unit is configured to parse the host interface commands into read commands, write commands, encoding/decoding mode, host interface types, and target addresses. The command parsing unit parses the commands sent from various host interfaces to obtain specific command data, such as whether it is a read command or a write command, as well as the encoding/decoding mode, host interface type, and the storage address (security level) of the data.

In a preferred embodiment of the present application, as shown in FIG. 3, the storage controller module further includes a storage read sequence generation unit and an ECC control module. The storage read sequence generation unit is configured to receive information about the read command and target address parsed by the command parsing unit, generate a storage read control instruction based on the information, and send the storage read control instruction to the storage module to read the corresponding data to be encoded/decoded in the storage module into the ECC control module. The ECC control module is configured to receive information about the encoding/decoding mode and host interface type parsed by the command parsing unit, send the encoding/decoding mode, host interface type, and data to be encoded/decoded to the ECC codec module for processing. The ECC control module is also configured to receive the encoded/decoded data sent from the ECC codec module, perform ECC verification on the encoded/decoded data, and send the verified data to the gating and arbitration module. If the host interface command is a read command, then the ECC codec module is set to be in the decoding mode. Based on the received host interface command, the ECC codec module is informed which cached H matrix to use for decoding. Based on the received host interface command (after parsing), the security level address area is determined. The storage read sequence generation unit generates a storage read control instruction based on the address information, and sends the storage read control instruction to the storage module to read the corresponding data to be encoded/decoded in the storage module into the ECC control module. The ECC control module sends the encoding/decoding mode, host interface type, and data to be encoded/decoded to the ECC codec module for processing. The ECC codec module sends the processed encoded/decoded data to the ECC control module. The ECC control module performs ECC verification on the encoded/decoded data and sends the verified data to the gating and arbitration module. The gating and arbitration module sends the corrected data to the corresponding host interface.

In a preferred embodiment of the present application, as shown in FIG. 3, the storage controller module further includes a storage write sequence generation unit. The storage write sequence generation unit is configured to receive information about the write command and target address parsed by the command parsing unit, generate a storage write control instruction based on the information, and send the storage write control instruction to the storage module. The ECC control module is configured to receive information about the encoding/decoding mode, host interface type, and write data source parsed by the command parsing unit, send the encoding/decoding mode, host interface type, and the data source to be written to the ECC codec module for processing. The ECC control module is also configured to receive the encoded/decoded data sent from the ECC codec module and send the encoded/decoded data to the storage write sequence generation unit. The storage write sequence generation unit writes the encoded/decoded data into the storage module. If the host interface command is a write command, then the ECC codec module is set to be in the encoding mode. Based on the received host interface commands, the ECC codec module is informed which cached H matrix to use. Based on the received host interface commands, the security level address area is determined. The storage write sequence generation unit generates a storage write control instruction and sends it to the storage module. The ECC control module sends the parsed corresponding information and data to the ECC codec module for processing. The ECC codec module sends the processed encoded/decoded data to the ECC control module. The ECC control module sends the encoded/decoded data to the storage write sequence generation unit, and the storage write sequence generation unit writes the encoded/decoded data into the storage module.

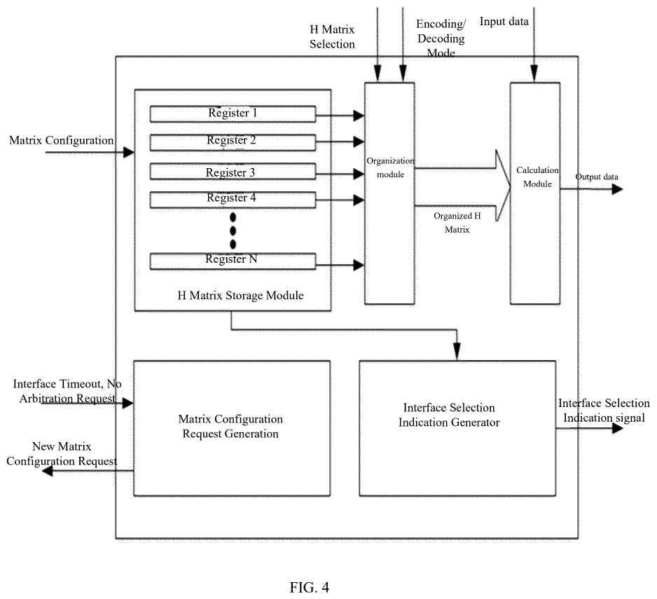

In a preferred embodiment of the present application, as shown in FIG. 4, the ECC codec module includes an H matrix storage module configured to store two sets of H matrices. The H matrix storage module includes a register group, and each register in the register group stores one row of data in the H matrix.

In a preferred embodiment of the present application, the number of registers in the register group is twice the number of rows of the H matrix with the largest number of rows among all H matrices. The H matrix storage module can also store more H matrices, and each register in the register group only stores one row of data of an H matrix. For example, if the H matrix is a 3*3 matrix, the first register stores the data of the first row, the second register stores the data of the second row, and the third register stores the data of the third row. The number of registers needs to be set according to the size of all H matrices. For example, if there are 10 sets of H matrices in the system and the H matrix with the largest number of rows among these 10 sets is a 10*10 matrix, then the number of registers is twice the largest number of rows, that is, 20 registers.

In a preferred embodiment of the present application, the H matrix storage module is connected to an external matrix configuration module, and is configured to receive configuration information sent from the external matrix configuration module and update the H matrices stored in the H matrix storage module based on the configuration information. When the two cached H matrices cannot meet the current calculation requirements and need to be updated, the cached H matrices are replaced according to the configuration information.

In a preferred embodiment of the present application, the H matrix storage module is configured to fill the redundant bits in the data stored in each register with zeros. For example, if the storage space of each register is 10, and the two cached H matrices are a 3*3 matrix and a 5*5 matrix, all the empty positions in both matrices will be filled with zeros.

In a preferred embodiment of the present application, as shown in FIG. 4, the ECC codec module further includes a organization module connected to the H matrix storage module. The organization module is configured to receive each row of data of the H matrix sent from the H matrix storage module and organize the received data of each row into an H matrix.

In a preferred embodiment of the present application, the organization module is further configured to, when the ECC codec module is in the encoding mode, select a set number of high-order bits from each row of data to form an H matrix, and fill zeros in the high-order bits of the formed H matrix.

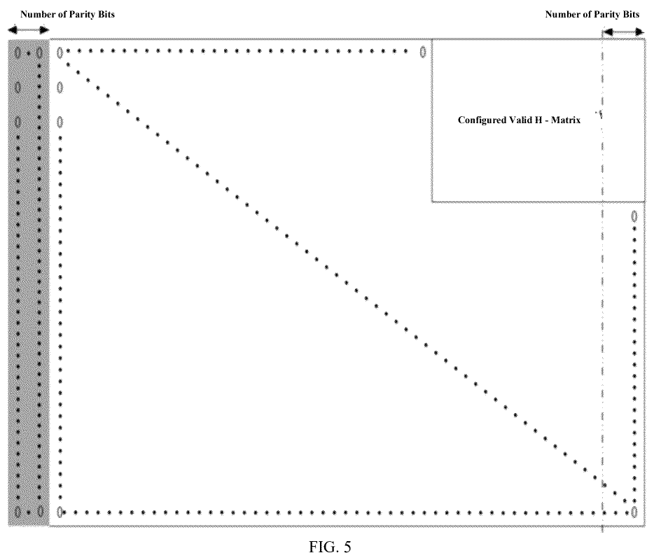

In a preferred embodiment of the present application, the set number is the value obtained by subtracting the number of parity bits from the number of columns of the H matrix. As shown in FIG. 5, for example, when the ECC codec module is in the encoding mode, the selected H matrix is a 10*10 matrix and there are 3 parity bits, 7 high-order bits of the 10*10 matrix are selected to form an H matrix, that is, the lower 3 bits of data in each register are not read. At this time, the formed H matrix is 10*7 matrix. Next, 3 high-order bits of the formed H matrix are filled with zeros to make the H matrix as a 10*10 matrix, so as to meet the requirement of outputting the maximum number of columns of the parity-check matrix, that is, all the parts to the left of the dotted line in FIG. 5.

In a preferred embodiment of the present application, the organization module is further configured to, when the ECC codec module is in the decoding mode, select a preset number of low-order bits from each row of data to form an H matrix.

In a preferred embodiment of the present application, the preset number is the number of columns of the H matrix.

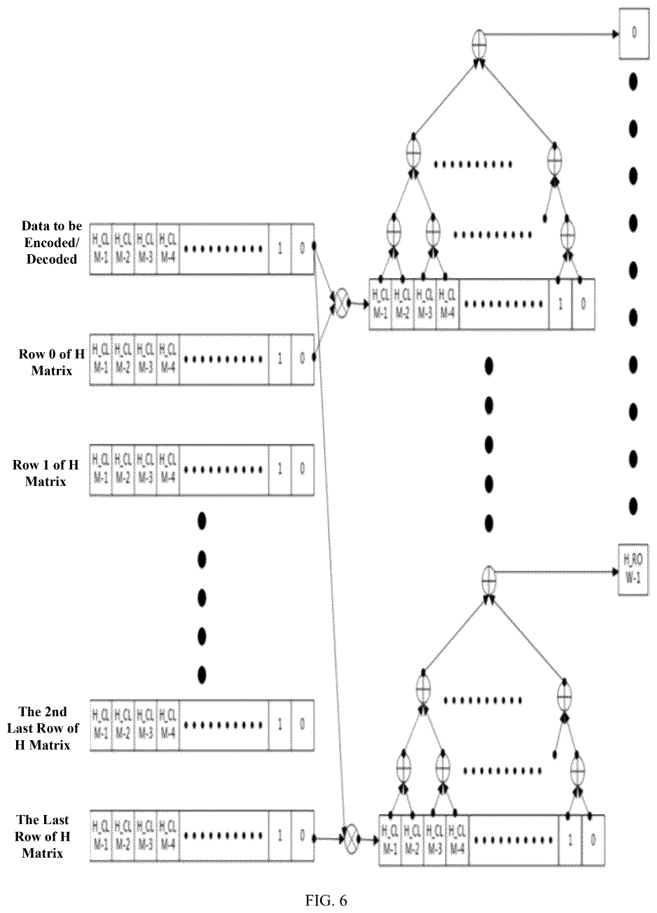

In a preferred embodiment of the present application, as shown in FIG. 4, the ECC codec module further includes a calculation module connected to the organization module and the storage controller module. The calculation module receives the data to be encoded/decoded sent from the storage controller module and the H matrix sent from the organization module, encodes/decodes the data to be encoded/decoded according to the H matrix, and sends the encoded/decoded data to the storage controller module. Resources for dot product and XOR operations are allocated according to the maximum supported size of the H matrix, and the encoding and decoding calculations share the same module. The bit width of the input parity-check matrix or generator matrix of the calculation module is: the maximum number of rows of the H matrix*the maximum number of columns of the H matrix, and the input data to be encoded/decoded is the maximum number of columns of the H matrix. As shown in FIG. 6, the input data to be encoded/decoded and the H matrix input to the calculation module by the organization module are grouped for dot product operations. After the dot product operations, each group performs XOR operations on its own, and the final result is the output encoded/decoded value, that is, the data to be processed undergoes a dot product operation with each row of the H matrix. For data of each calculation result, XOR operations are performed on every two bits of the data until a single value is obtained for each result. The final combined values of these results yield the output encoding or decoding values. This design mainly takes advantage of two characteristics: (1) Any number multiplied by 0 is equal to 0; (2) XOR calculation is insensitive to 0. Since the input parity-check matrix or generator matrix is set to 0 where it does not match the largest H matrix, the result of multiplying these unmatched positions by the incoming data to be encoded or decoded will be 0. Subsequent XOR operations involving these zeros will not affect the final result.

In a preferred embodiment of the present application, the ECC codec module also includes a matrix configuration request generation unit. When the interface timeout signal is input or there is no arbitration request signals, it indicates that two new H matrices need to be configured into the cache. When all the calculations inside the ECC codec module are completed and it is in an idle state, a new matrix configuration request signal is generated.

In a preferred embodiment of the present application, the the ECC codec module also includes an interface selection indication generation unit. This unit continuously scans the types of the cached H matrices. When an H matrix is refreshed, the interface selection indication output to the outside is changed. The two cached H matrices correspond to at least two host interfaces, that is, the interface selection indication output to the outside is greater than or equal to 2.

The present application provides a solution for distinguishing different security levels of data to be stored and dynamically changing the ECC code rate. When the data to be stored is high-security-level data with a high security level, this segment of data is allocated to a storage region with a high proportion of parity bits to enhance error correction capabilities. When the data to be stored is low-security-level data with a low security level, this segment of data is allocated to a storage region with a low proportion of parity bits to save storage space and increase the proportion of valid data in the storage space. The calculation unit of the codec of the present application only allocates one set of resources. By configuring different modes, the encoding operation or the decoding operation can be selected. The storage H matrix unit only allocates a cache capable of storing two maximum H matrices. Through a H matrix reconfiguration mechanism, resource consumption can be significantly reduced.

The present application has the following advantages. The storage verification system provided by the embodiments of the present application includes: a gating and arbitration module, connected to all host interfaces and configured to receive data sent from the host interfaces and send data to the host interfaces; a storage controller module, connected to the gating and arbitration module and configured to receive a host interface command and data sent from the gating and arbitration module, parse the host interface command received, and send decoded data to the host interfaces; an ECC codec module connected to the gating and arbitration module and the storage controller module, wherein the ECC codec module is configured to: send an interface selection indication signal to the gating and arbitration module to enable the gating and arbitration module to select a corresponding host interface; receive the host interface command and data sent from the storage controller module, encode or decode the data based on the host interface command, and send encoded or decoded data to the storage controller module; and a storage module connected to the storage controller module, wherein the storage module is configured to store the encoded data and ECC parity data sent from the storage controller module, and send the encoded data and the ECC parity data to the ECC codec module. Such solution can enhance data error correction capability, save storage space, and significantly reduce resource consumption.

In view of the above objectives, a second aspect of the embodiments of the present application provides a server including a storage verification system, and the storage verification system includes a gating and arbitration module, a storage controller module, an ECC codec module and a storage module.

The gating and arbitration module is connected to various host interfaces, and configured to receive data sent from the host interfaces and send data to the host interfaces.

The storage controller module is connected to the gating and arbitration module, and configured to receive host interface commands and data sent from the gating and arbitration module, parse the received host interface commands, and send decoded data to various host interfaces.

The ECC codec module is connected to the gating and arbitration module and the storage controller module. The ECC codec module is configured to send an interface selection indication signal to the gating and arbitration module to enable the gating and arbitration module to select the corresponding host interface. The ECC codec module is also configured to receive the host interface commands and data sent from the storage controller module, encode or decode the data based on the host interface commands, and send the encoded or decoded data to the storage controller module.

The storage module is connected to the storage controller module, and configured to store the encoded data and ECC parity data sent from the storage controller module, and send the encoded data and ECC parity data to the ECC codec module.

Although the embodiments of the present application have been shown and described, for those skilled in the art, it is understandable that various changes, modifications, substitutions, and variations can be made to these embodiments without departing from the principles and spirit of the present application. The scope of the present application is defined by the appended claims and their equivalents.

The above embodiments, especially any “preferred” embodiments, are possible examples of implementation and are proposed only to clearly understand the principles of the present application. Many changes and modifications can be made to the above embodiments without departing from the spirit and principles of the technology described herein. All modifications are intended to be included within the scope of this disclosure and are protected by the appended claims.

1. A storage verification system, comprising:
a gating and arbitration device, connected to all host interfaces and configured to receive data sent from the host interfaces and send data to the host interfaces;
a storage controller, connected to the gating and arbitration device and configured to receive host interface commands and data sent from the gating and arbitration device, parse the host interface commands received, and send decoded data to the host interfaces;
an ECC codec connected to the gating and arbitration device and the storage controller, wherein the ECC codec is configured to: send an interface selection indication signal to the gating and arbitration device to enable the gating and arbitration device to select a corresponding host interface; receive the host interface commands and data sent from the storage controller, encode or decode the data based on the host interface commands, and send encoded or decoded data to the storage controller; and
a memory connected to the storage controller, wherein the memory is configured to store the encoded data and ECC parity data sent from the storage controller, and send the encoded data and the ECC parity data to the ECC codec.

2. The storage verification system according to claim 1, wherein the memory comprises several partitions with a different security levels, a storage space for the ECC parity data in a partition with a high security level is larger than a storage space for the ECC parity data in a partition with a low security level; the memory is configured to store the encoded data and the ECC parity data into corresponding partitions based on the security levels of the data sent from different host interfaces.

3. The storage verification system according to claim 1, wherein the gating and arbitration device comprises a host interface selector connected to all the host interfaces, and the host interface selector is configured to receive the interface selection indication signal sent from the ECC codec, and receive the host interface commands and data sent from the host interfaces based on the received interface selection indication signal.

4. The storage verification system according to claim 3, wherein the gating and arbitration device further comprises an arbiter connected to the host interface selector and the storage controller; the arbiter is configured to: arbitrate, among a plurality of host interface commands and data received by the host interface selector, using a round-robin scheduling algorithm; select a group of host interface command and data among the plurality of host interface commands and data; and send the group of host interface command and data to the storage controller.

5. The storage verification system according to claim 4, wherein the gating and arbitration device further comprises a monitor connected to the host interface selector and the ECC codec, wherein the monitor is configured to, in response to determining that no request signal exists at the arbiter and request signals exist at the host interface selector, send an H matrix switching signal to the ECC codec; in response to receiving the H matrix switching signal, the ECC codec sends a new interface selection indication signal to the host interface selector, allowing new host interface commands and data to enter the arbiter.

6. The storage verification system according to claim 5, wherein the monitor is connected to the arbiter, and is further configured to, in response to determining that a threshold number of commands and data of the current host interface are continuously processed and requests from other host interfaces exist in the arbiter, send a timeout signal to the ECC codec, allowing commands and data of other host interfaces in the arbiter to be sent to the storage controller.

7. The storage verification system according to claim 1, wherein the storage controller comprises a command parser connected to the gating and arbitration device, the command parser is configured to receive the host interface commands and data sent from the gating and arbitration device, and parse the host interface commands into a read command, a write command, an encoding/decoding mode, a host interface type, and a target address.

8. The storage verification system according to claim 7, wherein the storage controller further comprises a storage read sequence generator and an ECC controller; the storage read sequence generator is configured to receive information about the read command and target address parsed by the command parser, generate a storage read control instruction based on the information, and send the storage read control instruction to the memory to read corresponding data to be encoded/decoded in the memory into the ECC controller; the ECC controller is configured to receive information about the encoding/decoding mode and the host interface type parsed by the command parser, send the encoding/decoding mode, the host interface type, and the data to be encoded/decoded to the ECC codec for processing; the ECC controller is further configured to receive the encoded/decoded data sent from the ECC codec, perform ECC verification on the encoded/decoded data, and send verified data to the gating and arbitration device.

9. The storage verification system according to claim 8, wherein the storage controller further comprises a storage write sequence generator; the storage write sequence generator is configured to receive information about the write command and target address parsed by the command parser, generate a storage write control instruction based on the information, and send the storage write control instruction to the memory; the ECC controller is configured to receive information about the encoding/decoding mode, the host interface type, and write data source parsed by the command parser, send the encoding/decoding mode, the host interface type, and the write data source to the ECC codec for processing; the ECC controller is further configured to receive the encoded/decoded data sent from the ECC codec and send the encoded/decoded data to the storage write sequence generator; the storage write sequence generator writes the encoded/decoded data into the memory.

10. The storage verification system according to claim 1, wherein the ECC codec comprises an H matrix cache configured to store two sets of H matrices, and the H matrix cache comprises a register group, and each register in the register group is used for storing one row of data in the H matrix.

11. The storage verification system according to claim 10, wherein a number of registers in the register group is twice a number of rows in the H matrix with the largest number of rows among all H matrices.

12. The storage verification system according to claim 11, wherein the H matrix cache is configured to receive configuration information, and update the H matrices stored in the H matrix cache based on the configuration information.

13. The storage verification system according to claim 12, wherein the H matrix cache is configured to fill redundant bits in the data stored in each register with zeros.

14. The storage verification system according to claim 10, wherein the ECC codec further comprises an H matrix generator that is connected to the H matrix cache and configured to receive each row of data in the H matrix sent from the H matrix cache and organize the received rows of data into the H matrix.

15. The storage verification system according to claim 14, wherein the H matrix generator is further configured to, in response to the ECC codec being in the encoding mode, select a set number of high-order bits from each row of data to form the H matrix and fill zeros in high-order bits of the formed H matrix.

16. The storage verification system according to claim 15, wherein the set number is a value obtained by subtracting the number of parity bits from the number of columns of the H matrix.

17. The storage verification system according to claim 14, wherein the H matrix generator is further configured to, in response to the ECC codec being in the decoding mode, select a preset number of low-order bits from each row of data to form the H matrix.

18. The storage verification system according to claim 17, wherein the preset number is the number of columns of the H matrix.

19. The storage verification system according to claim 14, wherein the ECC codec further comprises a calculation device connected to the H matrix generator and the storage controller; the calculation device is configured to receive the data to be encoded/decoded sent from the storage control module and the H matrix sent from the H matrix generator, encode/decode the data to be encoded/decoded according to the H matrix, and send the encoded/decoded data to the storage controller.

20. A server comprising a storage verification system, wherein the storage verification system comprises:
a gating and arbitration device, connected to all host interfaces and configured to receive data sent from the host interfaces and send data to the host interfaces;
a storage controller, connected to the gating and arbitration device and configured to receive host interface commands and data sent from the gating and arbitration device, parse the host interface commands received, and send decoded data to the host interfaces;
an ECC codec connected to the gating and arbitration device and the storage controller, wherein the ECC codec is configured to: send an interface selection indication signal to the gating and arbitration device to enable the gating and arbitration device to select a corresponding host interface; receive the host interface commands and data sent from the storage controller, encode or decode the data based on the host interface commands, and send encoded or decoded data to the storage controller; and
a memory connected to the storage controller, wherein the memory is configured to store the encoded data and ECC parity data sent from the storage controller, and send the encoded data and the ECC parity data to the ECC codec.
